(19) United States
(12) Patent Application Publication
(10) Pub. No.: US 2022/0364871 A1
(43) Pub. Date: Nov. 17, 2022

(54) STORAGE MEDIUM AND FIRST TERMINAL

(71) Applicant: TOYOTA JIDOSHA KABUSHIKI KAISHA, Toyota-shi (JP)

(72) Inventor: Ai YASHIRO, Nagoya-shi (JP)

(73) Assignee: TOYOTA JIDOSHA KABUSHIKI KAISHA, Toyota-shi (JP)

(21) Appl. No.: 17/686,656

(22) Filed: Mar. 4, 2022

(30) Foreign Application Priority Data
May 13, 2021 (JP) 2021-081798

(51) Int. Cl. G01C 21/34; G06Q 10/02; G06K 7/14

(52) U.S. Cl. CPC G01C 21/3438; G01C 21/3484; G06Q 10/02; G06K 7/143

(57) ABSTRACT

A storage medium storing an information processing program for controlling a first terminal which is used by a first user who has an administrator right for a specific vehicle is provided. The information processing program causes the first terminal to perform a step of acquiring a second user ID from a second terminal which is used by a second user who wants to use the specific vehicle and a step of transmitting a registration request signal for requesting registration of the second user ID in a predetermined list to a management server device.

### CROSS-REFERENCE TO RELATED APPLICATION

This application claims priority to Japanese Patent Application No. 2021-081798 filed on May 13, 2021, incorporated herein by reference in its entirety.

### BACKGROUND

### 1. Technical Field

The present disclosure relates to a technique of managing a control right for a vehicle.

### 2. Description of Related Art

A key information sharing system is disclosed in Japanese Unexamined Patent Application Publication No. 2019-92011 (JP 2019-92011 A). In the key information sharing system disclosed in JP 2019-92011 A, a delivery device adds transferable information for enabling a user terminal and a third-party terminal to transfer key information to each other without passing through the delivery device to the key information. In the key information sharing system, when transferable information is added to the key information received from the delivery device, the user terminal transmits the key information to the third-party terminal in response to a user's input operation.

### SUMMARY

The present disclosure provides a technique which is effective for a first user to grant a control right for a specific vehicle to a second user.

A first aspect of the present disclosure can be understood as a storage medium storing an information processing program for controlling a first terminal which is used by a first user who has an administrator right for a specific vehicle. For example, the information processing program may cause the first terminal to perform: a first step of acquiring a second user ID which is a user ID of a second user who wants to use the specific vehicle from a second terminal which is used by the second user; and a second step of transmitting a request for granting a control right for the specific vehicle to the second terminal on which the second user ID is used for login to a management server device that manages the control right for the specific vehicle.

A second aspect of the present disclosure can be understood as a first terminal that is used by a first user who has an administrator right for a specific vehicle. Here, for example, the first terminal may include a control unit configured to acquire a second user ID which is a user ID of a second user who wants to use the specific vehicle from a second terminal which is used by the second user and to transmit a request for granting a control right for the specific vehicle to the second terminal on which the second user ID is used for login to a management server device that manages the control right for the specific vehicle.

A third aspect of the present disclosure can be understood as a storage medium storing an information processing program for controlling a second terminal which is used by a second user who does not have an administrator right for a specific vehicle. Here, for example, the information processing program may cause the second terminal to perform a third step of acquiring a first user ID which is a user ID of a first user who has an administrator right for the specific vehicle from the first terminal which is used by the first user, and a fourth step of transmitting a request for granting the control right for the specific vehicle correlated with the first user ID to the second terminal on which the second user ID is used for login to a management server device that manages the control right for the specific vehicle.

The present disclosure can also be understood as a method for causing a first terminal to perform the processes which are performed in the first aspect, a second terminal that performs the processes which are performed in the third aspect, or a method for causing the second terminal to perform the processes which are performed in the third aspect.

According to the present disclosure, it is possible to provide a technique which is effective for a first user to grant a control right for a specific vehicle to a second user.

### BRIEF DESCRIPTION OF THE DRAWINGS

Features, advantages, and technical and industrial significance of exemplary embodiments of the invention will be described below with reference to the accompanying drawings, in which like signs denote like elements, and wherein:

FIG. 1 is a diagram schematically illustrating a vehicle management system according to an embodiment;

FIG. 2 is a block diagram schematically illustrating an example of configurations of a first terminal, a second terminal, a management server device, and an onboard device which are included in the vehicle management system according to the embodiment;

FIG. 3 is a diagram illustrating an example of an operation screen which is displayed on the first terminal when a second user ID is acquired from the second terminal according to the embodiment;

FIG. 4 is a diagram illustrating an example of an operation screen which is displayed on the first terminal when a first user sets a grant period according to the embodiment;

FIG. 5 is a diagram illustrating an example of an operation screen which is displayed on the second terminal when a second user ID is provided to the first terminal according to the embodiment;

FIG. 6 is a diagram illustrating an example of a configuration of a vehicle information table stored in a vehicle management DB;

FIG. 7 is a sequence diagram illustrating signals which are transmitted and received among the first terminal, the second terminal, and the management server device and processes which are performed by the constituents when a first user grants a control right for a specific vehicle to a second user according to the embodiment;

FIG. 8 is a flowchart illustrating a process routine which is performed by the first terminal when a first user grants a control right for a specific vehicle to a second user according to the embodiment;

FIG. 9 is a sequence diagram illustrating signals which are transmitted and received among the second terminal, the onboard device, and the management server device and processes which are performed by the constituents when a second user operates a specific vehicle using the second terminal;

FIG. 10 is a block diagram schematically illustrating an example of a configuration of a first terminal, a second terminal, a management server device, and an onboard device which are included in the vehicle management system according to a modified example;

FIG. 11 is a diagram illustrating an example of an operation screen which is displayed on the first terminal when a first user ID is provided to the second terminal; and

FIG. 12 is a sequence diagram illustrating signals which are transmitted and received among the first terminal, the second terminal, and the management server device and processes which are performed by the constituents when a first user grants a control right for a specific vehicle to a second user according to the modified example.

### DETAILED DESCRIPTION OF EMBODIMENTS

An information processing program according to the present disclosure is installed in a first terminal which is used by a first user who has an administrator right for a specific vehicle. The first terminal in which the information processing program according to the present disclosure is installed acquires a second user ID from a second terminal. Then, the first terminal transmits a request to a management server device. The request is a signal for requesting to grant a control right for the specific vehicle to the second terminal on which a second user ID is used for login. The management server device having received the request grants the control right for the specific vehicle to the second terminal on which the second user ID is used for login. Accordingly, the second user can control the specific vehicle using the second terminal by logging in on the second terminal with the second user ID. As a result, the control right for the specific vehicle is granted to the second user by the first user.

As the method of allowing the first terminal to acquire the second user ID from the second terminal, a method of reading the second user ID which is displayed on a screen of the second terminal using a camera of the first terminal can be used. With this method, when the first terminal acquires the second user ID from the second terminal, the first user and the second user need to meet. As a result, it is possible to prevent a malicious third party from pretending to be the first user or the second user.

The second user ID displayed on the screen of the second terminal may be displayed as a two-dimensional code. Accordingly, even when a third party sees the two-dimensional code displayed on the screen of the second terminal, it is difficult for the third party to ascertain the second user ID. As a result, it is possible to prevent the second user ID from being inappropriately used by a third party. The two-dimensional code may be a QR code (registered trademark). Accordingly, the first terminal can rapidly and accurately read the second user ID displayed on the screen of the second terminal. The two-dimensional code is not limited to the QR code and may be a matrix type two-dimensional code or a stack type two-dimensional code.

The control right for the specific vehicle which is granted to the second terminal on which the second user ID is used for login may be restricted to a predetermined range. For example, the predetermined range is narrower than a range of the administrator right and includes a right to remotely operate the specific vehicle. Accordingly, it is possible to prevent a right equivalent to that of the first user from being granted to the second user. As a result, the second user is prevented from enforcing a right which may cause a disadvantage to the first user (for example, rights to read and change information associated with ownership or a right of use of the specific vehicle, rights to perform a procedure requiring billing or the like, and rights to grant the control right for the specific vehicle to a terminal of another user).

Here, when the management server device is configured to grant the control right for the specific vehicle to a terminal on which a user ID registered in a predetermined list is used for login, a control unit of the first terminal may transmit a registration request signal for requesting registration of the acquired second user ID in the predetermined list as the request to the management server device. In this case, when the management server device registers the second user ID in the predetermined list, the control right for the specific vehicle is granted to the second terminal on which the second user ID is used for login.

In addition to a user ID, a period in which the control right for the specific vehicle is granted to a terminal on which the user ID is used for login (a grant period) may be registered in the predetermined list. In this case, the first terminal may allow the first user to input a grant period for the second user ID (a grant period for the second terminal on which the second user ID is used for login) in addition to acquiring the second user ID from the second terminal before transmitting the registration request signal to the management server device. The first terminal may transmit the registration request signal including the grant period input by the first user to the management server device in addition to the second user ID. The management server device having received the registration request signal registers the second user ID and the grant period in the predetermined list in correlation with each other. Accordingly, the management server device can grant the control right for the specific vehicle to the second terminal on which the second user ID is used for login in only the grant period. As a result, it is possible to prevent the specific vehicle from being used by the second user when the first user wants to use the specific vehicle.

Registration of the second user ID in the predetermined list may be performed by the second user using the second terminal. In this case, the second terminal can acquire the first user ID which is a user ID of the first user from the first terminal. The second terminal can transmit a request for granting the control right for the specific vehicle correlated with the first user ID to the second terminal on which the second user ID is used for login to the management server device.

Hereinafter, a specific embodiment of the present disclosure will be described with reference to the accompanying drawings. The configuration described in this embodiment is not intended to limit the technical scope of the present disclosure thereto unless otherwise mentioned.

### Embodiment

### Summary of System

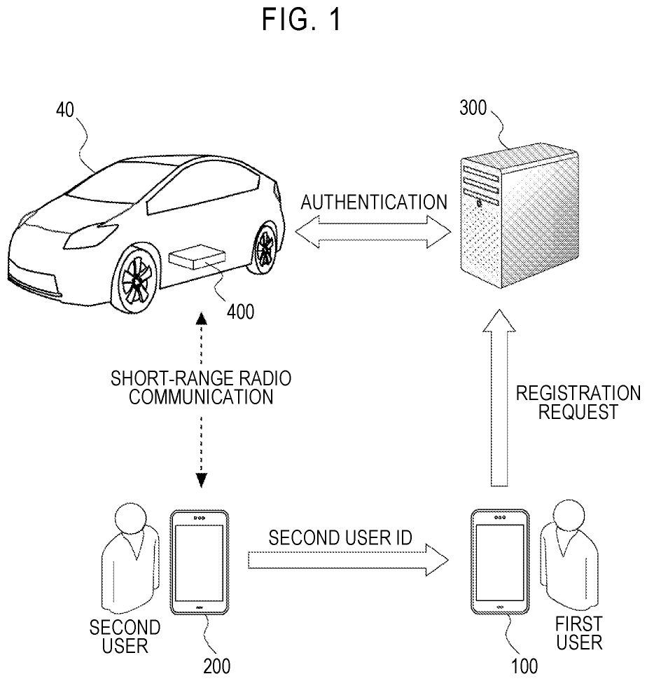

FIG. 1 is a diagram illustrating a summary of a vehicle management system to which the present disclosure is applied. The vehicle management system according to this embodiment is a system that provides a service for allowing a first user to grant a control right for a specific vehicle 40 to a second user (hereinafter also referred to as a “right granting service”). This vehicle management system includes a first terminal 100, a second terminal 200, a management server device 300, and an onboard device 400. The first terminal 100, the second terminal 200, the management server device 300, and the onboard device 400 are connected to each other via a network. For example, the network is a wide area network (WAN) which is a global public communication network such as the Internet. The second terminal 200 and the onboard device 400 perform communication based on a short-range radio communication standard. The short-range radio communication standard is, for example, Bluetooth (registered trademark) Low Energy (hereinafter also referred to as “BLE”) or Wi-Fi (registered trademark).

The first terminal 100 is a computer that is used by the first user. The first terminal 100 is a small computer which can be carried by the first user such as a smartphone, a mobile phone, a tablet terminal, or a wearable computer (such as a smart wrist watch). The first user is a master user who has an administrator right for the specific vehicle 40. The master user of the specific vehicle 40 is only one user (the first user in this example) such as a user who has ownership of the specific vehicle 40 (a user who has purchased the specific vehicle 40 from a vehicle sales company or the like) or a user who has a right of use of the specific vehicle 40 (a user who leases the specific vehicle 40 from a vehicle lease company or the like). Here, the first user may be a master user of a plurality of vehicles including the specific vehicle 40. The administrator right of the master user includes a right to grant a control right for the specific vehicle 40 to a user other than the master user (a user who does not have the administrator right for the specific vehicle 40). The “control right” mentioned herein is limited to a part of the administrator right of the master user. For example, the control right is limited to a right to perform a remote operation of the specific vehicle 40 (for example, an operation of locking/unlocking a door or an operation of locking/unlocking a trunk), a right to read information on a status of the specific vehicle 40, and the like. That is, the control right does not include a right which may cause a disadvantage to the master user such as a right to read and change information associated with ownership or a right of use of the specific vehicle 40, a right to perform a procedure requiring billing or the like, or a right to grant the control right for the specific vehicle 40 to another user.

A first application program is installed on the first terminal 100 in this example. In the first terminal 100, the first application program serves to realize various functions for granting the control right for the specific vehicle 40 to a user other than the master user. The functions for granting the control right for the specific vehicle 40 to a user other than the master user are realized by allowing the first user to input a first user ID on a login screen which is displayed on the first terminal 100 at the time of starting execution of the first application program. The first user ID is a user ID which is given to the master user (the first user) of the specific vehicle 40 and is given when the first user acquires ownership or a right of use of the specific vehicle 40.

The second terminal 200 is a computer that is used by a second user. The second user is a user other than the first user and is a user who does not have the administrator right for the specific vehicle 40. Similarly to the first terminal 100, the second terminal 200 is a small computer which can be carried by the second user. A second application program is installed on the second terminal 200 in this example. In the second terminal 200, the second application program serves to realize various functions for acquiring the control right for the specific vehicle 40. The functions for acquiring the control right for the specific vehicle 40 are realized by allowing the second user to input a second user ID on a login screen which is displayed on the second terminal 200 at the time of starting execution of the second application program. The second user ID is a user ID which is given when the second user performs user registration for a right granting service. When the second user logs in with the second user ID in a period (a grant period) in which the control right for the specific vehicle 40 is granted to the second user by the first user, the second application program realizes functions for realizing a remote operation of the specific vehicle 40 in the second terminal 200.

Here, the first application program and the second application program may have different configurations or the same configuration. When the first application program and the second application program have the same configuration, the programs may be designed such that different functions are realized according to attributes of a user who logs in. For example, the first application program and the second application program may be designed such that the same function as in the first terminal 100 is realized when the user who logs in to the application program is the master user of the specific vehicle 40, and the same function as in the second terminal 200 is realized when the user who logs in to the application program is a user other than the master user of the specific vehicle 40.

The management server device 300 is a computer that is managed by a sales company of the specific vehicle 40, a telematics service provider (TSP), or the like. The management server device 300 manages the control right for the specific vehicle 40. For example, the management server device 300 receives a registration request signal from the first terminal 100. The registration request signal is a signal for requesting registration of a user ID (a second user ID) of a user (the second user) to whom the first user intends to grant the control right for the specific vehicle 40 in an authorized user list. The authorized user list is a list in which a user ID of a user to whom the control right for the specific vehicle 40 is granted by the first user is registered (hereinafter also referred to as an “authorized user”). Details of the authorized user list will be described later. The management server device 300 having received the registration request signal from the first terminal 100 registers the user ID (the second user ID) of the user to be registered (the second user) in the authorized user list. A vehicle which is managed by the management server device 300 is not limited to the specific vehicle 40 and may include two or more vehicles.

The management server device 300 also has a function of receiving an authentication request signal from the onboard device 400 which will be described later. The authentication request signal is a signal for requesting authentication of a user who wants to use the specific vehicle 40. The management server device 300 having received the authentication request signal from the onboard device 400 determines whether the user ID of the user who wants to use the specific vehicle 40 is registered in the authorized user list. When the user ID of the user who wants to use the specific vehicle 40 is registered in the authorized user list, the management server device 300 determines that the authentication is successful. On the other hand, when the user ID of the user who wants to use the specific vehicle 40 is not registered in the authorized user list, the management server device 300 determines that the authentication has failed. The result of authentication in the management server device 300 is transmitted from the management server device 300 to the onboard device 400.

The onboard device 400 is a computer which is mounted in the specific vehicle 40. The onboard device 400 has a function of transmitting an authentication request signal to the management server device 300 when a remote signal is received from the second terminal 200. The remote signal is a signal for remotely controlling unlocking of a door of the specific vehicle 40, locking of the door of the specific vehicle 40, locking of a trunk of the specific vehicle 40, unlocking of the trunk of the specific vehicle 40, and the like. When the management server device 300 has successfully authenticated the second user, the onboard device 400 receives a remote operation from the second terminal 200.

In the vehicle management system according to this embodiment, when a first user grants the control right for the specific vehicle 40 to a second user, the first user performs an operation for acquiring the second user ID from the second terminal 200 of the second user and an operation for registering the acquired second user ID in the authorized user list which will be described later using the first terminal 100. The second user performs an operation for providing the second user ID to the first terminal 100 of the first user using the second terminal 200. Transferring of the second user ID between the first terminal 100 and the second terminal 200 is performed using a two-dimensional code such as a QR code (registered trademark). That is, transferring of the second user ID from the second terminal 200 to the first terminal 100 is performed by causing the second terminal 200 to display the QR code indicating the second user ID and causing the first terminal 100 to read the QR code displayed on the second terminal 200. With this method, transferring of the second user ID is performed in a state in which the first user and the second user have met. As a result, it is possible to prevent a malicious third party from pretending to be the first user or the second user.

### System Configuration

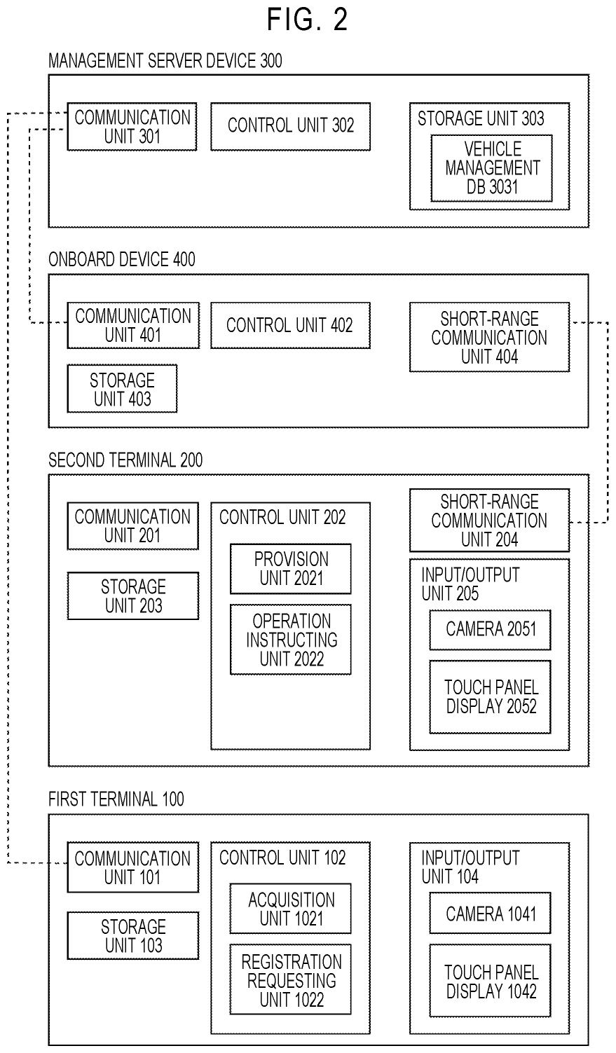

FIG. 2 is a block diagram schematically illustrating an example of configurations of the first terminal 100, the second terminal 200, the management server device 300, and the onboard device 400 which are included in the vehicle management system.

### First Terminal 100

The first terminal 100 is a small computer which is carried by the first user. As illustrated in FIG. 2, the first terminal 100 includes a communication unit 101, a control unit 102, a storage unit 103, and an input/output unit 104.

The communication unit 101 is a communication interface that connects the first terminal 100 to the network. For example, the communication unit 101 is connected to the network using a radio communication network and communicates with another device (for example, the management server device 300) via the network. The radio communication network is, for example, a mobile communication network such as 5th Generation (5G) or Long Term Evolution (LTE) or Wi-Fi. The network is, for example, a WAN as described above.

The control unit 102 is constituted by a processor such as a central processing unit (CPU) or a digital signal processor (DSP) and takes charge of control of the first terminal 100. The control unit 102 includes functional modules such as an acquisition unit 1021 and a registration requesting unit 1022. These functional modules are realized by causing the processor to execute a first application program stored in the storage unit 103 which will be described later. Some or all functions of the acquisition unit 1021 and the registration requesting unit 1022 may be realized by a hardware circuit such as an application-specific integrated circuit (ASIC) or a field-programmable gate array (FPGA).

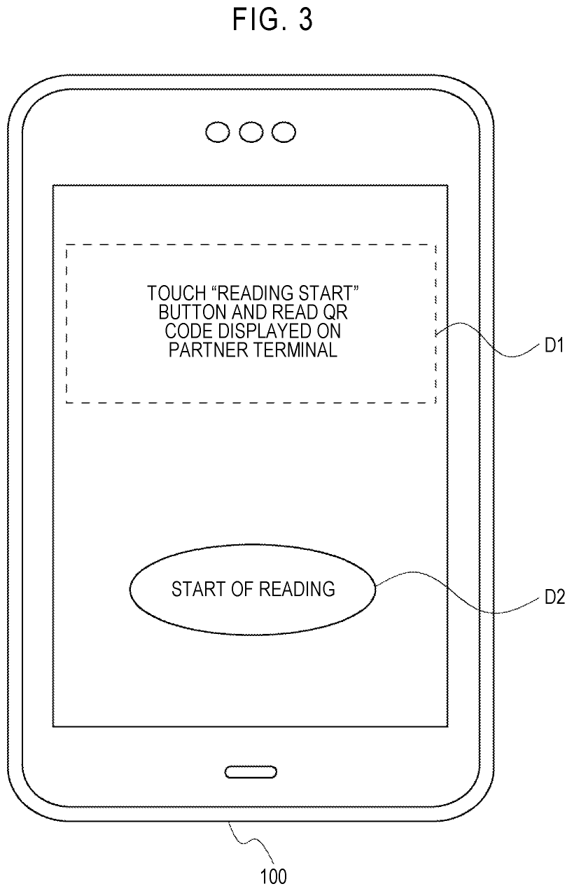

The acquisition unit 1021 performs a process of acquiring the second user ID from the second terminal 200. Specifically, the acquisition unit 1021 displays an operation screen illustrated in FIG. 3 on a touch panel display 1042 of the input/output unit 104 which will be described later. That is, the acquisition unit 1021 displays a screen including a message prompting the first user to read the QR code displayed on the second terminal 200 (D1 in FIG. 3) and a button for starting reading of the QR code (D2 in FIG. 3) on a touch panel display 1042 of the input/output unit 104. The operation screen illustrated in FIG. 3 is called from a menu screen which is displayed on the touch panel display 1042 of the input/output unit 104 after login using the first user ID has been performed. When the first user sees the screen illustrated in FIG. 3 and operates the button D2 (a “reading start” button) in FIG. 3, the acquisition unit 1021 starts a camera 1041 of the input/output unit 104 which will be described later and reads the QR code displayed on the second terminal 200. The acquisition unit 1021 performs image processing on the QR code read by the camera 1041 and derives the second user ID. The derived second user ID is delivered from the acquisition unit 1021 to the registration requesting unit 1022.

The registration requesting unit 1022 performs a process of registering the second user ID in the authorized user list of the management server device 300. Specifically, the registration requesting unit 1022 generates a registration request signal. The registration request signal is a signal for requesting registration of the second user ID in the authorized user list managed by the management server device 300 and includes the first user ID and the second user ID. The registration request signal generated by the registration requesting unit 1022 is transmitted to the management server device 300 via the communication unit 101.

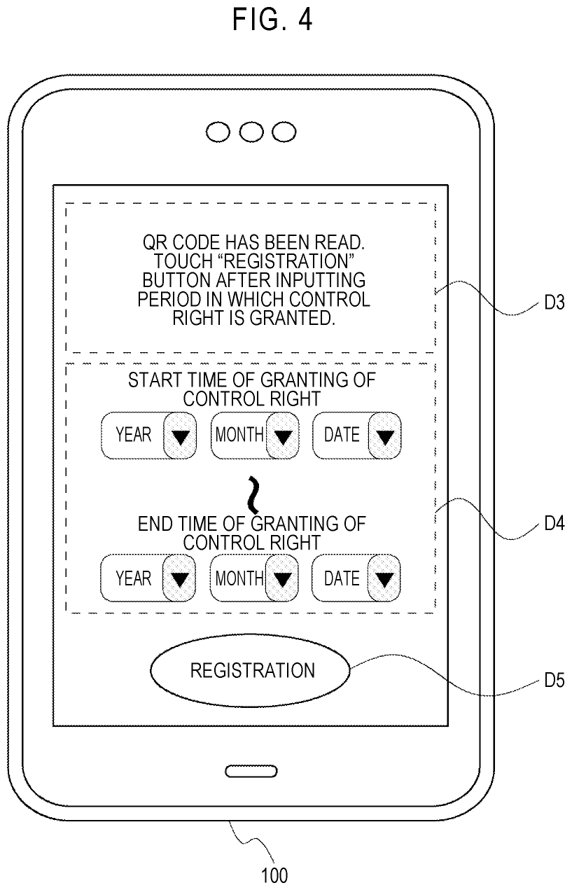

The registration request signal in this example includes a period (hereinafter also referred to as a “grant period”) in which the control right for the specific vehicle 40 is granted to the second user (the second terminal 200 on which the second user ID is used for log-in) in addition to the first user ID and the second user ID. Accordingly, the registration requesting unit 1022 performs a process of prompting the first user to input the grant period before transmitting the registration request signal to the management server device 300. Specifically, the registration requesting unit 1022 displays a screen illustrated in FIG. 4 on the touch panel display 1042 of the input/output unit 104 at the timing at which the second user ID has been received from the acquisition unit 1021. That is, the registration requesting unit 1022 displays a screen including a message (D3 in FIG. 4) indicating successful reading of the QR code, prompting input of the grant period, and explaining an operation which is performed after the grant period has been input, a pull-down menu (D4 in FIG. 4) for inputting the grant period, and a button (D5 in FIG. 4) that is operated after the grant period has been input on the touch panel display 1042 of the input/output unit 104. The first user having seen the screen illustrated in FIG. 4 selects and inputs a granting start time and a granting end time of the control right in the pull-down menu and operates the button D5 (a “registration” button) in FIG. 4. When the “registration” button indicated by D5 in FIG. 4 is operated, the registration requesting unit 1022 generates a registration request signal including the first user ID, the second user ID, and the grant period. The registration request signal generated by the registration requesting unit 1022 is transmitted to the management server device 300 via the communication unit 101.

When registration of the second user ID in the authorized user list in the management server device 300 is completed, a registration completion signal is transmitted from the management server device 300 to the first terminal 100. When the registration completion signal from the management server device 300 is received by the communication unit 101, the registration requesting unit 1022 displays information indicating that granting of the control right to the second user has been completed on the touch panel display 1042 of the input/output unit 104. The registration completion signal is a signal indicating that registration of the second user ID in the authorized user list has been completed.

The functional modules including the acquisition unit 1021 and the registration requesting unit 1022 are realized based on the premise that login using the first user ID (the user ID of the master user) has been performed at the time of starting of execution of the first application program.

Referring back to FIG. 2, the storage unit 103 includes a main storage device and an auxiliary storage device. The main storage device is a storage device that is used as a storage area for log-in to a program stored in the auxiliary storage device or that is used as a buffer for temporarily storing results of calculation or the like of the control unit 102. The main storage device includes, for example, a semiconductor memory such as a read only memory (ROM) and a random access memory (RAM). The auxiliary storage device stores a program which is executed by the control unit 102, and data which is used for the control unit 102 to execute the program, or the like. The auxiliary storage device includes, for example, an erasable programmable ROM (EPROM) or a hard disk drive (HDD). The auxiliary storage device may include a removable medium, that is, a portable storage medium. For example, the removable medium may be a disc storage medium such as a compact disc (CD) or a digital versatile disc (DVD) or may be a Universal Serial Bus (USB) memory. The program stored in the auxiliary storage device includes the first application program in addition to an operating system (OS). Some or all information stored in the auxiliary storage device may be stored in the main storage device.

The input/output unit 104 receives an input operation which is performed by the first user and presents information to the first user. The input/output unit 104 includes, for example, the camera 1041 and a control circuit thereof and the touch panel display 1042 and a control circuit thereof. The input/output unit 104 may additionally include a microphone and a control circuit thereof and a speaker and a control circuit thereof. In this example, when the QR code displayed on the second terminal 200 is read, the input/output unit 104 operates the camera 1041 to read the QR code.

The configuration of the first terminal 100 is not limited to the example illustrated in FIG. 2, and omission, substitution, or addition of an element may be appropriately performed thereon.

### Second Terminal 200

The second terminal 200 is a small computer which is carried by the second user. As illustrated in FIG. 2, the second terminal 200 includes a communication unit 201, a control unit 202, a storage unit 203, a short-range communication unit 204, and an input/output unit 205.

Similarly to the communication unit 101 of the first terminal 100, the communication unit 201 is a communication interface that communicates with another device (for example, the management server device 300) via the network.

The control unit 202 is constituted by a processor such as a CPU or a DSP and takes charge of control of the second terminal 200. The control unit 202 includes functional modules such as a provision unit 2021 and an operation instructing unit 2022. These functional modules are realized by causing the processor to execute a second application program stored in the storage unit 203 which will be described later. Some or all functions of the provision unit 2021 and the operation instructing unit 2022 may be realized by a hardware circuit such as an ASIC or an FPGA.

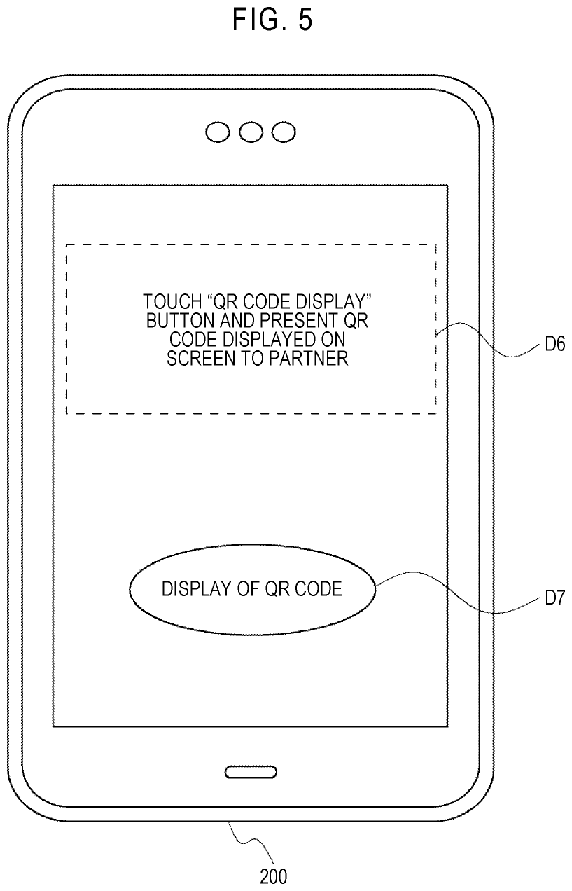

The provision unit 2021 performs a process of providing the second user ID to the first terminal 100. Specifically, the provision unit 2021 displays an operation screen illustrated in FIG. 5 on a touch panel display 2052 of the input/output unit 205 which will be described later. That is, the provision unit 2021 displays a screen including a message indicating that the second user is prompted to display the QR code and that the second user is prompted to present the displayed QR code to the first user (D6 in FIG. 5) and a button for displaying the QR code (D7 in FIG. 5) on the touch panel display 2052 of the input/output unit 205. The operation screen illustrated in FIG. 5 is called from a menu screen which is displayed on the touch panel display 2052 of the input/output unit 205 after log-in using the second user ID has been performed. When the second user seeing the screen illustrated in FIG. 5 operates the button D7 (a “QR code display” button) in FIG. 5, the provision unit 2021 displays the QR code on the touch panel display 2052 of the input/output unit 205. The QR code is formed by converting a character string indicating the second user ID to a QR code format. The second user ID is a user ID which is granted when registration of a user in the second application program has been performed and is used for log-in for use of the second application program. When the QR code is displayed on the touch panel display 2052 of the second terminal 200, the second user presents a screen in which the QR code is displayed to the first user. Accordingly, the first user can allow the first terminal 100 to read the QR code of the second user by calling the operation screen illustrated in FIG. 3 using the first terminal 100 and operating the “reading start” button (D2 in FIG. 3).

The operation instructing unit 2022 displays an operation screen on the touch panel display 2052 of the input/output unit 205 and generates an instruction based on an operation performed by the second user. Specifically, the operation instructing unit 2022 displays an operation screen including a plurality of buttons for performing various remote operations such as unlocking of a door, locking of the door, unlocking of a trunk, and locking of the trunk on the touch panel display 2052 of the input/output unit 205. When the user operates an arbitrary button on the operation screen, the operation instructing unit 2022 generates a remote control signal based on the button operated by the user. The remote control signal is a signal including information for identifying a remote operation performed by the second user and the second user ID. The operation performed by the user is not limited to an operation using the touch panel display 2052 and may be performed using a hardware switch or the like.

The functional module of the provision unit 2021 is realized based on the premise that log-in is performed using a user ID of a user to which the control right for the specific vehicle 40 is not granted at the time of starting of execution of the second application program. The functional module of the operation instructing unit 2022 is realized based on the premise that log-in is performed using a user ID of a user to which the control right for the specific vehicle 40 is granted at the time of starting of execution of the second application program. Specifically, when the log-in timing is outside of the grant period, the second application program causes the control unit 202 to realize the functional module of the provision unit 2021. When the log-in timing is inside of the grant period, the second application program causes the control unit 202 to realize the functional module of the operation instructing unit 2022.

Referring back to FIG. 2, the storage unit 203 includes a main storage device and an auxiliary storage device. The hardware configuration of the main storage device and the auxiliary storage device is the same as that of the storage unit 103 of the first terminal 100 and thus description thereof will be omitted. A program which is stored in the auxiliary storage device includes the second application program in addition to an OS. The second application program is a program for realizing the functional modules such as the provision unit 2021 and the operation instructing unit 2022. Data stored in the auxiliary storage device includes information indicating a grant period. The information indicating a grant period is included in the registration completion signal which is transmitted from the management server device 300 which will be described later to the second terminal 200, and is stored in the auxiliary storage device at a time point at which the second terminal 200 receives the registration completion signal. Some or all information stored in the auxiliary storage device may be stored in the main storage device.

The short-range communication unit 204 is a communication interface that performs short-range radio communication with the onboard device 400. For example, the short-range communication unit 204 performs short-range (for example, about 1 meter to 2 meters) communication using a predetermined radio communication standard. The predetermined radio communication standard is, for example, BLE. The predetermined radio communication standard may be a near-field communication (NFC), an ultra-wide band (UWB) or a Wi-Fi.

The input/output unit 205 receives an input operation which is performed by the second user and presents information to the second user. The input/output unit 205 includes, for example, the camera 2051 and a control circuit thereof, the touch panel display 2052 and a control circuit thereof, a microphone and a control circuit thereof, and a speaker and a control circuit thereof similarly to the input/output unit 104 of the first terminal 100. In this example, when the QR code is presented to the first terminal 100, the input/output unit 205 displays the QR code on the touch panel display 2052.

The configuration of the second terminal 200 is not limited to the example illustrated in FIG. 2, and omission, substitution, or addition of an element may be appropriately performed thereon.

### Management Server Device 300

The management server device 300 is constituted by a general-purpose computer. For example, as illustrated in FIG. 2, the management server device 300 includes a communication unit 301, a control unit 302, and a storage unit 303.

Similarly to the communication unit 101 of the first terminal 100, the communication unit 301 is a communication interface that communicates with another device (for example, the first terminal 100 and the onboard device 400) via the network.

The control unit 302 is constituted by a processor such as a CPU or a DSP and takes charge of control of the management server device 300. In this example, when the communication unit 301 receives a registration request signal from the first terminal 100, the control unit 302 registers the second user ID and the grant period included in the registration request signal in an authorized user list which will be described later. When registration of the second user ID and the grant period in the authorized user list is completed, the control unit 302 transmits a registration completion signal to the first terminal 100 and the second terminal 200 via the communication unit 301. Here, the registration completion signal for the second terminal 200 includes information indicating the grant period.

When the communication unit 301 receives an authentication request signal from the onboard device 400 which will be described later, the control unit 302 authenticates the second user by comparing a second user ID included in the authentication request signal with the user ID registered in the authorized user list. Here, when the second user ID is registered in the authorized user list, it is determined that authentication is successful. On the other hand, when the second user ID is not registered in the authorized user list, it is determined that authentication has failed. The result of authentication of the second user is transmitted from the communication unit 301 to the onboard device 400.

When the grant period is determined, the second user ID is registered in the authorized user list, and a date at which the authentication request signal has been received is in the grant period, the control unit 302 determines that authentication is successful. When the second user ID is not registered in the authorized user list and/or a date at which the authentication request signal is received is not in the grant period, the control unit 302 determines that authentication has failed.

The storage unit 303 includes a main storage device and an auxiliary storage device. The hardware configuration of the main storage device and the auxiliary storage device is the same as that of the storage unit 103 of the first terminal 100 and thus description thereof will be omitted. A program which is stored in the auxiliary storage device includes a program for realizing a function of registering the second user ID in the authorized user list and a program for realizing a function of authenticating the second user based on the second user ID in addition to an OS. A vehicle management DB 3031 is constructed in the auxiliary storage device. The vehicle management DB 3031 is constructed by a database management system (DBMS) program which is executed by the control unit. Specifically, the vehicle management DB 3031 is constructed by causing the DBMS program to manage data stored in the auxiliary storage device. Here, the vehicle management DB 3031 may be constructed as a relational database (RDB).

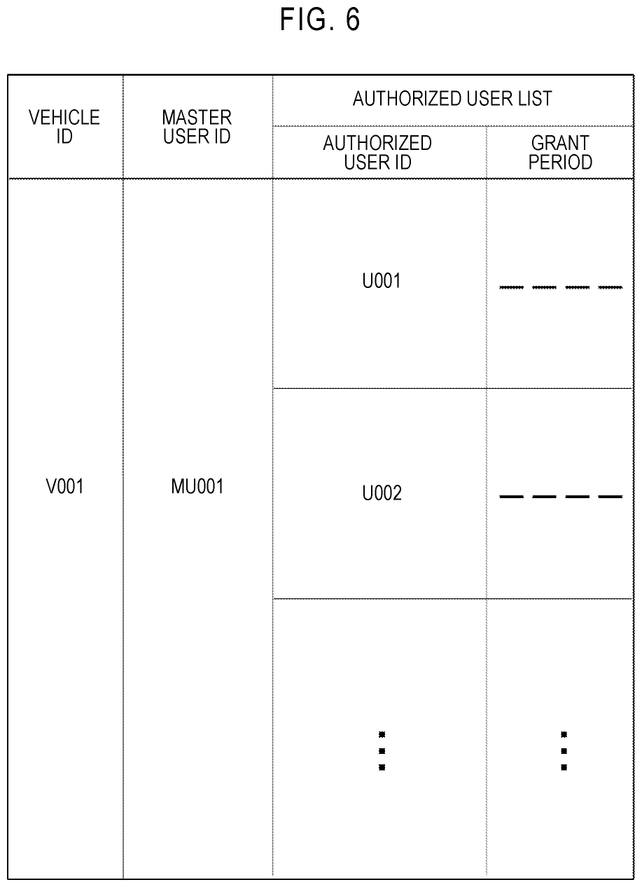

The vehicle management DB 3031 registers information for correlating a specific vehicle 40, a master user, and an authorized user. Here, a configuration example of information stored in the vehicle management DB 3031 will be described below with reference to FIG. 6. FIG. 6 is a diagram illustrating a table configuration of information which is stored in the vehicle management DB 3031. A table stored in the vehicle management DB 3031 (hereinafter also referred to as a “vehicle information table”) includes fields of vehicle ID, master user ID, authorized user list, and the like. In the example illustrated in FIG. 6, the vehicle information table corresponding to one vehicle is illustrated, but when the number of vehicles managed by the management server device 300 is two or more, vehicle information tables corresponding to the two or more vehicles are registered in the vehicle management DB 3031. The configuration of the vehicle information table is not limited to the example illustrated in FIG. 6, and addition, change, or deletion of a field can be appropriately performed thereon.

Identification information of the specific vehicle 40 (a vehicle ID) is registered in the vehicle ID field of the vehicle information table. A user ID of the master user of the specific vehicle 40 (the first user ID) is registered in the master user ID field. An authorized user list is registered in the authorized user list field. The authorized user list is a list in which a user ID of a user (an authorized user) to which the control right for the specific vehicle 40 is granted by the first user and a grant period for the authorized user are registered. When the first user grants the control right for the specific vehicle 40 to a plurality of users, user IDs and grant periods corresponding to the plurality of users are registered in the authorized user list. The grant period registered in the authorized user list is, for example, information including information indicating a start date of the grant period and information indicating an end date thereof.

The configuration of the management server device 300 is not limited to the example illustrated in FIG. 2, and addition, change, or deletion of an element can be appropriately performed thereon.

### Onboard Device 400

The onboard device 400 is a small computer which is mounted in a specific vehicle 40. As illustrated in FIG. 2, the onboard device 400 includes a communication unit 401, a control unit 402, a storage unit 403, and a short-range communication unit 404.

Similarly to the communication unit 101 of the first terminal 100, the communication unit 401 is a communication interface that communicates with another device (for example, the management server device 300) via the network.

The control unit 402 is constituted by a processor such as a CPU or a DSP and takes charge of control of the onboard device 400. In this example, when the short-range communication unit 404 receives a remote control signal from the second terminal 200, the control unit 402 transmits an authentication request signal to the management server device 300 via the communication unit 401. The authentication request signal is a signal for requesting authentication of the second user for determining whether the second user is an authorized user of the specific vehicle 40 and includes a vehicle ID and a second user ID. The second user ID which can be included in the authentication request signal in this case is the second user ID included in the remote control signal. The vehicle ID is a vehicle ID stored in the storage unit 403 which will be described later. When authentication of the second user is successful in the management server device 300, a signal indicating that authentication is successful is transmitted from the management server device 300 to the onboard device 400. When the communication unit 401 receives the signal, the control unit 402 receives a remote operation from the second terminal 200. For example, when the remote operation is an operation of unlocking a door of the specific vehicle 40, the control unit 402 unlocks the door of the specific vehicle 40. When authentication of the second user has failed in the management server device 300, a signal indicating that authentication has failed is transmitted from the management server device 300 to the onboard device 400. When the communication unit 401 receives the signal, the control unit 402 does not receive a remote operation from the second terminal 200. For example, when the remote operation is an operation of unlocking the door of the specific vehicle 40, the control unit 402 does not unlock the door of the specific vehicle 40.

When the second user in the specific vehicle 40 operates an onboard switch, the control unit 402 may transmit an authentication request signal to the management server device 300 via the communication unit 401. A second user ID which can be included in the authentication request signal in this case may be acquired from the second terminal 200 whenever the second user in the specific vehicle 40 operates the onboard switch. That is, when the second user in the specific vehicle 40 operates the onboard switch, first, the control unit 402 may acquire the second user ID from the second terminal 200 via the short-range communication unit 404. Subsequently, the control unit 402 may transmit an authentication request signal including the acquired second user ID and the vehicle ID stored in the storage unit 403 to the management server device 300 via the communication unit 401. When authentication of the second user is successful in the management server device 300, a signal indicating that authentication is successful is transmitted from the management server device 300 to the onboard device 400. When the communication unit 401 receives the signal, the control unit 402 may receive an operation which is performed by the second user. For example, when the onboard switch operated by the second user is a switch for starting or stopping a motor, the control unit 402 may start or stop the motor of the specific vehicle 40. When authentication of the second user has failed in the management server device 300, a signal indicating that authentication has failed is transmitted from the management server device 300 to the onboard device 400. When the communication unit 401 receives the signal, the control unit 402 may not receive an operation performed by the second user. For example, when the onboard switch operated by the second user is a switch for starting or stopping a motor, the control unit 402 may not start or stop the motor of the specific vehicle 40.

The storage unit 403 includes a main storage device and an auxiliary storage device. The hardware configuration of the main storage device and the auxiliary storage device is the same as that of the storage unit 103 of the first terminal 100 and thus description thereof will be omitted. A program which is stored in the auxiliary storage device includes a program for realizing a function of authenticating the second user in addition to an OS. Data stored in the auxiliary storage device includes the vehicle ID of the specific vehicle 40. Some or all information stored in the auxiliary storage device may be stored in the main storage device.

The configuration of the onboard device 400 is not limited to the example illustrated in FIG. 2, and omission, substitution, or addition of an element may be appropriately performed thereon.

### Flow of Processes

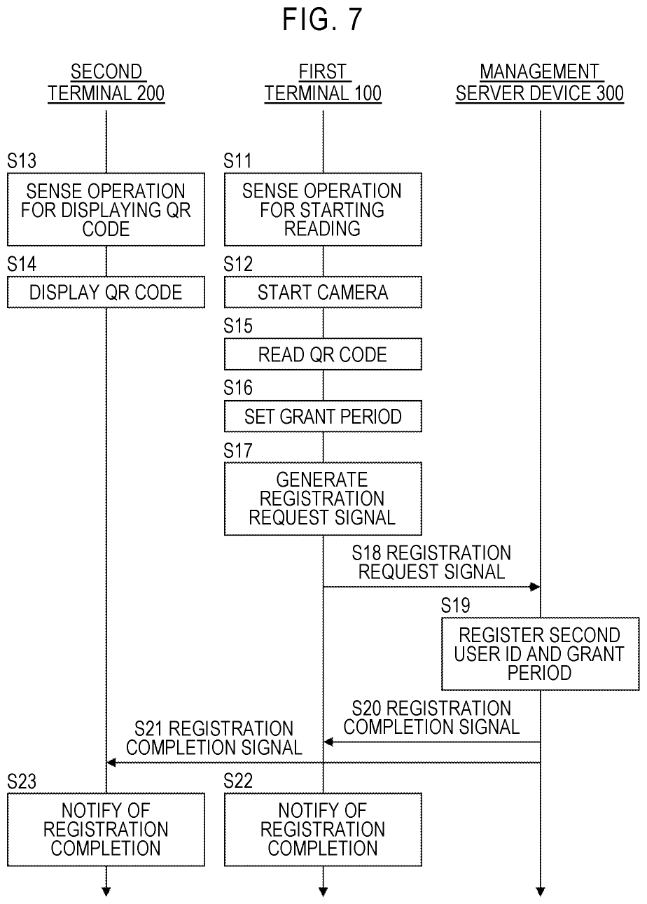

FIG. 7 is a sequence diagram illustrating signals which are transmitted and received among the first terminal 100, the second terminal 200, and the management server device 300 and processes which are performed by the constituents when the first user grants a control right for the specific vehicle 40 to the second user. It is assumed that the first user and the second user meet. It is also assumed that the operation screen illustrated in FIG. 3 is called in the first terminal 100 and the operation screen illustrated in FIG. 5 is called in the second terminal 200.

In FIG. 7, when the first user operates the “reading start” button (D2 in FIG. 3) in the operation screen displayed on the touch panel display 1042 of the first terminal 100 (the operation screen illustrated in FIG. 3), the operation is sensed by the control unit 102 (the acquisition unit 1021) of the first terminal 100 (S11). The control unit 102 having sensed the operation starts the camera 1041 of the input/output unit 104 (S12).

When the second user operates the “QR code display” button (D7 in FIG. 5) on the operation screen displayed on the touch panel display 2052 of the second terminal 200 (the operation screen illustrated in FIG. 5), the operation is sensed by the control unit 202 (the provision unit 2021) of the second terminal 200 (S13). The control unit 202 having sensed the operation displays a QR code on the touch panel display 2052 of the input/output unit 205 (S14).

When the camera 1041 of the first terminal 100 is started and the touch panel display 2052 of the second terminal 200 displays the QR code, the first user and the second user adjust relative positions between the first terminal 100 and the second terminal 200 such that the camera 1041 of the first terminal 100 can read the QR code displayed on the touch panel display 2052 of the second terminal 200. As a result, the camera 1041 of the first terminal 100 reads the QR code displayed on the touch panel display 2052 of the second terminal 200 (S15).

When the camera 1041 of the first terminal 100 reads the QR code, the control unit 102 (the registration requesting unit 1022) of the first terminal 100 sets a grant period (S16). That is, the control unit 102 of the first terminal 100 prompts the first user to input the grant period by displaying the operation screen illustrated in FIG. 4 on the touch panel display 1042 of the input/output unit 104.

When the first user inputs the grant period and then operates the “registration” button (D5 in FIG. 4), the control unit 102 of the first terminal 100 generates a registration request signal (S17). The registration request signal is a signal including the first user ID, the second user ID, and the grant period. The generated registration request signal is transmitted from the communication unit 101 of the first terminal 100 to the management server device 300 (S18).

When the communication unit 301 of the management server device 300 receives the registration request signal, the control unit 302 of the management server device 300 registers the second user ID and the grant period in the authorized user list (S19). Specifically, the control unit 302 identifies a vehicle information table in which the same user ID as the first user ID is registered in the master user ID field by accessing the vehicle management DB 3031 of the storage unit 303 using the first user ID included in the registration request signal as an argument. The control unit 302 registers the second user ID and the grant period included in the registration request signal in the authorized user list of the authorized user list field in the identified vehicle information table. When registration of the second user ID and the grant period in the authorized user list is completed, the control unit 302 transmits a registration completion signal to the first terminal 100 and the second terminal 200 via the communication unit 301 (S20 and S21). Here, the registration completion signal transmitted to the second terminal 200 includes information indicating the grant period.

The first terminal 100 having received the registration completion signal performs a process of notifying the first user that registration of the second user ID in the authorized user list has been completed (S22). For example, the control unit 102 displays a message indicating that registration of the second user ID in the authorized user list has been completed on the touch panel display 1042 of the input/output unit 104.

The second terminal 200 having received the registration completion signal performs a process of notifying the second user that registration of the second user ID in the authorized user list has been completed (S23). For example, the control unit 202 displays a message indicating that registration of the second user ID in the authorized user list has been completed on the touch panel display 2052 of the input/output unit 205. Information indicating the grant period, which is included in the registration completion signal, is stored in the auxiliary storage device of the second terminal 200.

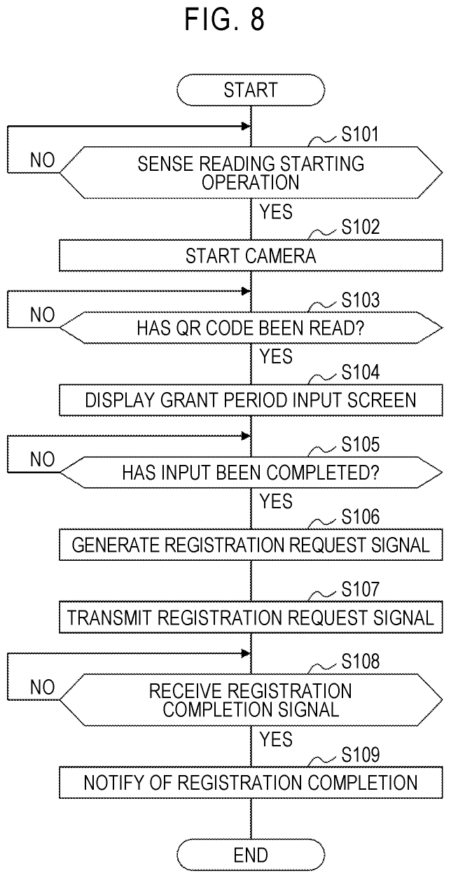

A flow of processes which are performed by the first terminal 100 when the first user grants the control right for the specific vehicle 40 to the second user will be described below with reference to FIG. 8. FIG. 8 is a flowchart illustrating a process routine which is performed by the first terminal 100 when the first user grants the control right for the specific vehicle 40 to the second user. The process routine illustrated in FIG. 8 is a process routine which is performed with calling of the operation screen illustrated in FIG. 3 as a trigger in a state in which log-in using the first user ID has been performed. A subject that performs the process routine illustrated in FIG. 8 is the control unit 102 of the first terminal 100, but functional elements of the first terminal 100 will be described as subjects.

In Step S101, the acquisition unit 1021 determines whether operation of the “reading start” button (D2 in FIG. 3) on the operation screen illustrated in FIG. 3 has been sensed. When the operation of the “reading start” button has not been sensed (NO in Step S101), the acquisition unit 1021 waits until the operation of the “reading start” button is sensed. When the first application program ends during the waiting or the like, execution of the process routine ends. On the other hand, when the operation of the “reading start” button has been sensed (YES in Step S101), the acquisition unit 1021 performs the process of Step S102.

In Step S102, the acquisition unit 1021 starts the camera 1041 of the input/output unit 104 such that the QR code displayed on the second terminal 200 can be read. The acquisition unit 1021 performs the process of Step S103 after performing the process of Step S102.

In Step S103, the acquisition unit 1021 determines whether the QR code displayed on the second terminal 200 has been read by the camera 1041. When the camera 1041 has not read the QR code (NO in Step S103), the acquisition unit 1021 waits until the camera 1041 reads the QR code. When the first application program ends during the waiting or the like, execution of the process routine ends. On the other hand, the camera 1041 has read the QR code (YES in Step S103), the acquisition unit 1021 converts the QR code read by the camera 1041 to the second user ID in a character string and sends the converted second user ID to the registration requesting unit 1022. The registration requesting unit 1022 having received the second user ID performs the process of Step S104.

In Step S104, the registration requesting unit 1022 displays the operation screen illustrated in FIG. 4 on the touch panel display 1042 of the input/output unit 104. The registration requesting unit 1022 performs the process of Step S105 after completing the process of Step S104.

In Step S105, the registration requesting unit 1022 determines whether inputting of the grant period by the first user has been completed. Here, when the “registration” button (D5 in FIG. 4) is operated in a state in which the grant period has been selected from a pull-down menu (D4 in FIG. 4) on the operation screen illustrated in FIG. 4, the registration requesting unit 1022 determines that inputting of the grant period by the first user has been completed (YES in Step S105). On the other hand, when the grant period has not been selected from the pull-down menu or the “registration” button has not been operated, the registration requesting unit 1022 determines that inputting of the grant period by the first user has not been completed (NO in Step S105). When the determination result of Step S105 is negative, the registration requesting unit 1022 waits until inputting of the grant period by the first user is completed. When the first application program ends during the waiting or the like, execution of the process routine ends. On the other hand, when the determination result of Step S105 is positive, the registration requesting unit 1022 performs the process of Step S106.

In Step S106, the registration requesting unit 1022 generates the registration request signal. As described above, the registration request signal is a signal for requesting registration of the second user ID in the authorized user list and includes the first user ID, the second user ID, and the grant period. The registration requesting unit 1022 performs the process of Step S107 after completing the process of Step S106.

In Step S107, the registration requesting unit 1022 transmits the registration request signal generated in Step S106 to the management server device 300 via the communication unit 101. The registration requesting unit 1022 performs the process of Step S108 after completing the process of Step S107.

In Step S108, the registration requesting unit 1022 determines whether the communication unit 101 has received a registration completion signal from the management server device 300. When the communication unit 101 has not received the registration completion signal from the management server device 300 (NO in Step S108), the registration requesting unit 1022 waits until the communication unit 101 receives the registration completion signal from the management server device 300. On the other hand, when the communication unit 101 has received the registration completion signal from the management server device 300 (YES in Step S108), the registration requesting unit 1022 performs the process of Step S109.

In Step S109, the registration requesting unit 1022 displays information indicating that granting of the control right to the second user has been completed on the touch panel display 1042 of the input/output unit 104. When the registration requesting unit 1022 completes the process of Step S109, the process routine ends.

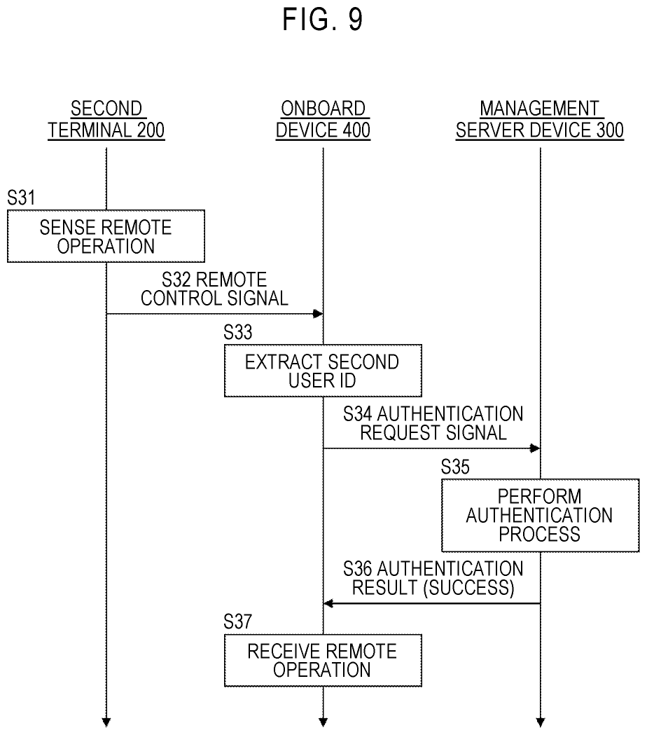

FIG. 9 is a sequence diagram illustrating signal which are transmitted and received among the second terminal 200, the onboard device 400, and the management server device 300 and processes which are performed by the constituent elements when the second user remotely operates the specific vehicle 40 using the second terminal 200. Here, it is assumed that registration of the second user ID in the authorized user list has been completed and a remote operation using the second terminal 200 by the second user has been performed in the grant period. It is also assumed that the second user is located in a range in which short-range communication between the second terminal 200 and the onboard device 400 is set up. It is also assumed that an operation screen including a plurality of buttons for various vehicle operations such as unlocking of a door, locking of the door, unlocking of a trunk, and locking of the trunk is displayed on the touch panel display 2052 of the second terminal 200.

In FIG. 9, when the second user operates an arbitrary button on the operation screen displayed on the touch panel display 2052 of the second terminal 200, a remote operation corresponding to the operated button is sensed by the control unit 202 (the operation instructing unit 2022) of the second terminal 200 (S31). The control unit 202 having sensed the remote operation transmits a remote control signal to the onboard device 400 via the short-range communication unit 204 (S32). The remote control signal includes information for identifying the remote operation corresponding to the button operated by the second user and the second user ID.

When a remote control signal is received by the short-range communication unit 404 of the onboard device 400, the control unit 402 of the onboard device 400 extracts the second user ID from the remote control signal (S33). The onboard device 400 generates an authentication request signal including the second user ID extracted from the remote control signal and the vehicle ID stored in the storage unit 403 and transmits the generated authentication request signal to the management server device 300 (S34). Transmission of the authentication request signal is performed via the communication unit 401.

When the authentication request signal is received by the communication unit 301 of the management server device 300, the control unit 302 of the management server device 300 performs an authentication process (S35). Specifically, the control unit 302 identifies a vehicle information table in which the same vehicle ID as the vehicle ID is registered in the vehicle ID field by accessing the vehicle management DB 3031 of the storage unit 303 using the vehicle ID included in the authentication request signal as an argument. The control unit 302 compares the user ID registered in the authorized user list of the authorized user list field in the identified vehicle information table with the second user ID included in the authentication request signal. When the same user ID as the second user ID is registered in the authorized user list, the control unit 302 determines whether a date at which the authentication request signal has been received (that is, a current date) is inside of the grant period registered in the authorized user list. When the date at which the authentication request signal has been received is inside of the grant period registered in the authorized user list, the control unit 302 determines that the authentication is successful. When the same user ID as the second user ID is not registered in the authorized user list and/or when the date at which the authentication request signal has been received is not inside of the grant period registered in the authorized user list, the control unit 302 determines that the authentication has failed. A signal indicating the result of the authentication process is transmitted from the communication unit 301 of the management server device 300 to the onboard device 400 (S36). Since the remote operation in the second terminal 200 by the second user is performed in the grant period in FIG. 9, it is determined that the authentication is successful in the authentication process of Step S35.

When the signal indicating the authentication result (success) is received by the communication unit 401 of the onboard device 400, the control unit 402 of the onboard device 400 receives a remote operation from the second terminal 200 (S37). That is, the control unit 402 controls the specific vehicle 40 in response to the remote operation.

According to the aforementioned embodiment, the first user can grant the control right for the specific vehicle 40 to the second user by registering the second user ID in the authorized user list of the management server device 300 using the first terminal 100 in which the first application program is installed. Accordingly, the second user can remotely operate the specific vehicle 40 using the second terminal 200 in which the second application program is installed.

According to this embodiment, transferring of the second user ID from the second user to the first user is performed by causing the camera 1041 of the first terminal 100 to read the QR code displayed on the touch panel display 2052 of the second terminal 200. Accordingly, since the first user and the second user need to meet when transferring of the second user ID is performed, it is possible to prevent a malicious third party from pretending to be the first user or the second user.

According to this embodiment, since the first user can arbitrarily set a grant period, it is also possible to prevent the specific vehicle 40 from being used by the second user when the first user wants to use the specific vehicle 40.

In this embodiment, an example in which the remote operation of the specific vehicle 40 using the second terminal 200 is performed by short-range radio communication has been described above, but the remote operation may be performed via a network. In this case, the second terminal 200 can transmit a remote control signal to the onboard device 400 via the communication unit 201.

### Modified Examples

In the aforementioned embodiment, an example in which the first user transmits a registration request to the management server device 300 using the first terminal 100 has been described above, but the second user may transmit a registration request to the management server device 300 using the second terminal 200.

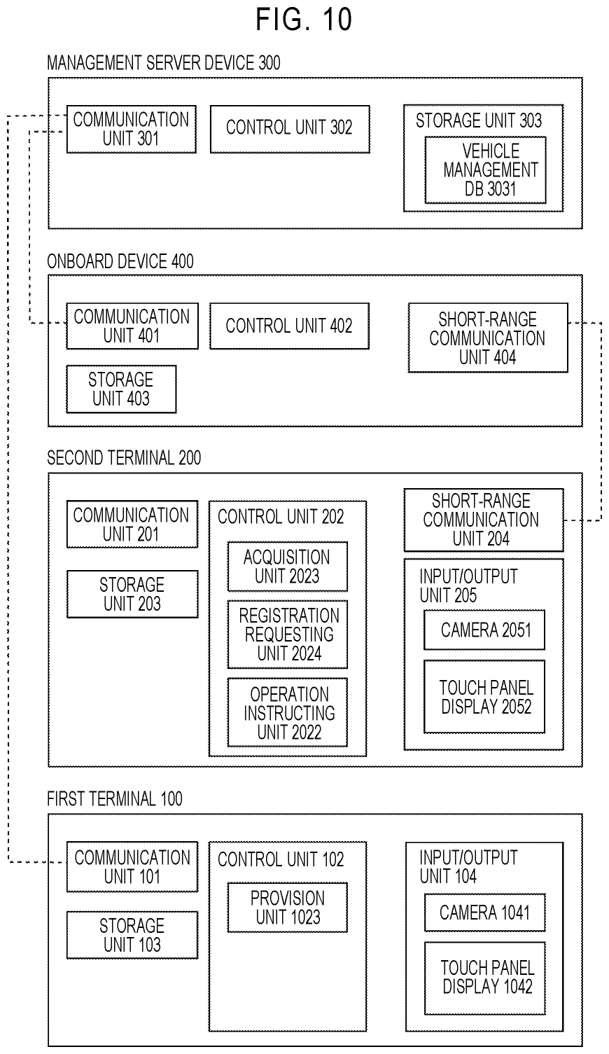

FIG. 10 is a block diagram schematically illustrating the configurations of the first terminal 100, the second terminal 200, the management server device 300, and the onboard device 400 according to a modified example. The same elements as illustrated in FIG. 2 will be referred to by the same reference signs. In the following description, elements different from those in the aforementioned embodiment will be described and description of the same elements will be omitted.

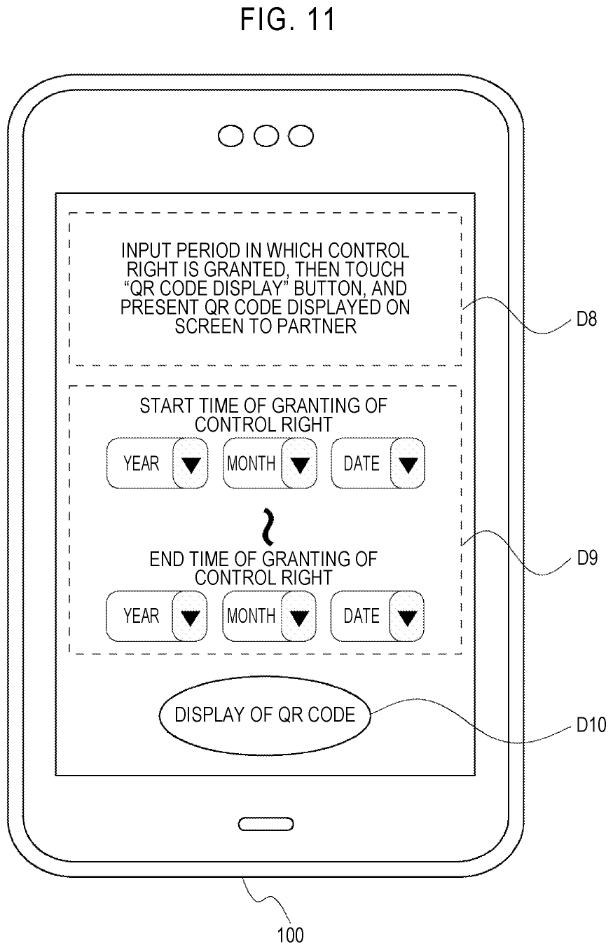

As illustrated in FIG. 10, the control unit 102 of the first terminal 100 includes a provision unit 1023 as a functional module thereof The provision unit 1023 performs a process of providing a first user ID and a grant period to the second terminal 200. Specifically, the provision unit 1023 displays an operation screen illustrated in FIG. 11 on the touch panel display 1042 of the input/output unit 104. That is, the provision unit 1023 displays a screen including a message indicating prompting of inputting of a grant period and description of an operation which is performed after inputting the grant period (D8 in FIG. 11), a pull-down menu for inputting the grant period (D9 in FIG. 11), and a button which his operated after inputting the grant period (D10 in FIG. 11) on the touch panel display 1042 of the input/output unit 104. The first user having seen the screen illustrated in FIG. 11 selectively inputs a granting start time and a granting end time of the control right from the pull-down menu and then operates the button D10 (a “QR code display” button) in FIG. 11. When the button D10 in FIG. 11 is operated, the provision unit 1023 displays a QR code on the touch panel display 1042 of the input/output unit 104. The QR code in this case is obtained by converting a combination of a character string indicating the first user ID and a character string indicating the grant period to a QR code format. When the QR code is displayed on the touch panel display 1042 of the first terminal 100, the first user presents the screen in which the QR code is displayed to the second user.

The control unit 202 of the second terminal 200 includes an acquisition unit 2023, a registration requesting unit 2024, and an operation instructing unit 2022 as functional modules thereof. The function of the operation instructing unit 2022 is the same as the operation instructing unit 2022 of the second terminal 200 in the aforementioned embodiment and thus description thereof will be omitted.

The acquisition unit 2023 performs a process of acquiring the first user ID from the first terminal 100. Specifically, the acquisition unit 2023 displays an operation screen for prompting the second user to read the QR code displayed on the first terminal 100 on the touch panel display 2052 of the input/output unit 205. This operation screen is the same as the operation screen illustrated in FIG. 3. When the second user having seen the operation screen operates the “reading start” button on the operation screen, the acquisition unit 2023 starts the camera 2051 of the input/output unit 205 to read the QR code displayed on the first terminal 100. The acquisition unit 2023 performs image processing on the QR code read by the camera 2051 and converts the QR code to the first user ID of a character string and the grant period of a character string. The converted first user ID and the converted grant period are sent from the acquisition unit 2023 to the registration requesting unit 2024.

The registration requesting unit 2024 generates a registration request signal. The registration request signal is a request for registering the second user ID in the authorized user list. The registration request signal in this case includes the first user ID, the second user ID, and the grant period. The registration request signal generated by the registration requesting unit 2024 is transmitted to the management server device 300 via the communication unit 201.

The functional modules of the acquisition unit 2023 and the provision unit 1023 are realized when a log-in timing using the second user ID is outside of the grant period. The functional module of the operation instructing unit 2022 is realized when the log-in timing using the second user ID is inside of the grant period.

The control unit 302 of the management server device 300 registers the second user ID and the grant period included in the registration request signal in the authorized user list when the registration request signal from the second terminal 200 is received by the communication unit 301. When registration of the second user ID and the grant period in the authorized user list is completed, the control unit 302 transmits a registration completion signal to the first terminal 100 and the second terminal 200 via the communication unit 301.

### Flow of Processes

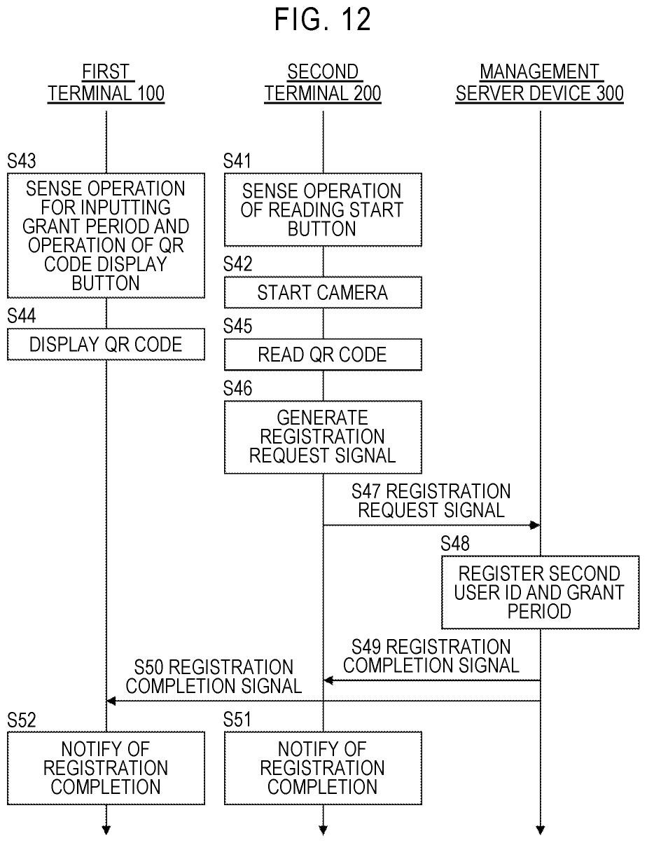

FIG. 12 is a sequence diagram illustrating signals which are transmitted and received among the first terminal 100, the second terminal 200, and the management server device 300 and processes which are performed by the constituents when the first user grants a control right for a specific vehicle 40 to the second user. It is assumed that the first user and the second user meet. It is also assumed that the operation screen illustrated in FIG. 11 is called in the first terminal 100 and the operation screen illustrated in FIG. 3 is called in the second terminal 200.

In FIG. 12, when the second user operates the “reading start” button (D2 in FIG. 3) in the operation screen displayed on the touch panel display 2052 of the second terminal 200 (the same operation screen as illustrated in FIG. 3), the operation is sensed by the control unit 202 (the acquisition unit 2023) of the second terminal 200 (S41). The control unit 202 having sensed the operation starts the camera 2051 of the input/output unit 205 (S42).

When the first user performs an operation of selecting inputting a grant period from the pull-down menu (D9 in FIG. 11) and an operation of operating the “QR code display” button (D10 in FIG. 11) on the operation screen displayed on the touch panel display 1042 of the first terminal 100 (the operation screen illustrated in FIG. 11), these operations are sensed by the control unit 102 (the provision unit 1023) of the first terminal 100 (S43). The control unit 102 having sensed the operations displays a QR code on the touch panel display 1042 of the input/output unit 104 (S44). The QR code in this case is formed by converting a combination of a character string indicating the first user ID and a character string of the grant period to a QR code format as described above.

When the QR code is displayed on the touch panel display 1042 of the first terminal 100 and the camera 2051 of the second terminal 200 is started, the first user and the second user adjust the relative position between the first terminal 100 and the second terminal 200 such that the camera 2051 of the second terminal 200 can read the QR code displayed on the touch panel display 1042 of the first terminal 100. As a result, the camera 2051 of the second terminal 200 reads the QR code displayed on the touch panel display 1042 of the first terminal 100 (S45).

When the camera 2051 of the second terminal 200 reads the QR code, the control unit 202 (the registration requesting unit 2024) of the second terminal 200 generates a registration request signal (S46). The registration request signal is a signal including the first user ID, the second user ID, and the grant period. The generated registration request signal is transmitted from the communication unit 201 of the second terminal 200 to the management server device 300 (S47).

When the registration request signal is received by the communication unit 301 of the management server device 300, the control unit 302 of the management server device 300 registers the second user ID and the grant period in the authorized user list (S48). Specifically, the control unit 302 identifies a vehicle information table in which the same user ID as the first user ID is registered in the master user ID field by accessing the vehicle management DB 3031 of the storage unit 303 using the first user ID included in the registration request signal as an argument. The control unit 302 registers the second user ID and the grant period included in the registration request signal in the authorized user list of the authorized user list field in the identified vehicle information table. When registration of the second user ID and the grant period in the authorized user list is completed, the control unit 302 transmits a registration completion signal to the first terminal 100 and the second terminal 200 via the communication unit 301 (S49 and S50).

The first terminal 100 having received the registration completion signal performs a process of notifying the first user that registration of the second user ID in the authorized user list has been completed (S51). The second terminal 200 having received the registration completion signal performs a process of notifying the second user that registration of the second user ID in the authorized user list has been completed (S52).

According to the aforementioned modified example, the second user can register the second user ID in the authorized user list of the management server device 300 by acquiring the first user ID using the second terminal 200 in which the second application program is installed. Accordingly, the second user can remotely operate the specific vehicle 40 using the second terminal 200 in which the second application program is installed.

According to the modified example, transferring of the first user ID from the first user to the second user is performed by causing the camera 2051 of the second terminal 200 to read the QR code displayed on the touch panel display 1042 of the first terminal 100. Accordingly, it is possible to prevent a malicious third party from pretending to be the first user or the second user.

According to the modified example, since the first user can arbitrarily set the grant period, it is also possible to prevent the specific vehicle 40 from being used by the second user when the first user wants to use the specific vehicle 40.

### Others

The aforementioned embodiment and modified example are only examples, and the present disclosure can be appropriately modified without departing from the gist thereof. The processes and units described above in the present disclosure can be freely combined unless technical conflictions arise.

A process which has been described to be performed by a single device may be divisionally performed by two or more devices. Alternatively, processes which have been described to be performed by different devices may be performed by a single device. In a computer system, what functions are realized by what hardware configuration can be flexibly changed.

The present disclosure can also be realized by supplying a computer program in which the functions described above in the embodiment and the modified example are mounted to a computer and causing one or more processors of the computer to read and execute the program. This computer program may be provided to the computer using a non-transitory computer-readable storage medium which can be connected to a system bus of the computer or may be provided to the computer via a network. For example, the non-transitory computer-readable storage medium includes an arbitrary type of disk such as a magnetic disk (such as a floppy (registered trademark) disk or a hard disk drive (HDD)) or an optical disc (such as a CD-ROM, a DVD disc, or a Blue-ray disc) or an arbitrary type of media suitable for storing electronic commands such as a read only memory (ROM), a random access memory (RAM), an erasable programmable ROM (EPROM), an electrically erasable programmable ROM (EEPROM), a magnetic card, a flash memory, or an optical card.

1. A non-transitory storage medium storing an information processing program for controlling a first terminal which is used by a first user who has an administrator right for a specific vehicle, the information processing program causing the first terminal to perform:
a first step of acquiring a second user ID which is a user ID of a second user who wants to use the specific vehicle from a second terminal which is used by the second user; and
a second step of transmitting a request for granting a control right for the specific vehicle to the second terminal on which the second user ID is used for login to a management server device that manages the control right for the specific vehicle.

2. The storage medium according to claim 1, wherein the first step includes a step of reading the second user ID which is displayed on a screen of the second terminal using a camera of the first terminal.

3. The storage medium according to claim 2, wherein the second user ID displayed on the screen of the second terminal is displayed as a two-dimensional code.

4. The storage medium according to claim 3, wherein the two-dimensional code is obtained by converting the second user ID to a QR code (registered trademark).

5. The storage medium according to claim 1, wherein the control right for the specific vehicle which is granted to the second terminal on which the second user ID is used for login is restricted to a predetermined range.

6. The storage medium according to claim 5, wherein the predetermined range includes a right to remotely operate the specific vehicle.

7. The storage medium according to claim 1, wherein the management server device serves to grant the control right for the specific vehicle to a terminal on which a user ID registered in a predetermined list is used for login, and
wherein the second step includes a step of transmitting a registration request signal for requesting registration of the second user ID in the predetermined list as the request to the management server device.

8. The storage medium according to claim 7, wherein the predetermined list is a list in which a grant period in which the control right for the specific vehicle is granted to a terminal on which a user ID is used for login in addition to the user ID is registered, and
wherein the second step includes:
a step of allowing the first user to input a grant period for the second user ID; and
a step of transmitting the registration request signal including the second user ID and the grant period to the management server device.

9. A first terminal that is used by a first user who has an administrator right for a specific vehicle, the first terminal comprising a control unit configured to:
acquire a second user ID which is a user ID of a second user who wants to use the specific vehicle from a second terminal which is used by the second user; and
transmit a request for granting a control right for the specific vehicle to the second terminal on which the second user ID is used for login to a management server device that manages the control right for the specific vehicle.

10. The first terminal according to claim 9, wherein the control unit is configured to acquire the second user ID by reading the second user ID which is displayed on a screen of the second terminal using a camera of the first terminal.

11. The first terminal according to claim 10, wherein the second user ID displayed on the screen of the second terminal is displayed as a two-dimensional code.

12. The first terminal according to claim 11, wherein the two-dimensional code is obtained by converting the second user ID to a QR code (registered trademark).

13. The first terminal according to claim 9, wherein the control right for the specific vehicle which is granted to the second terminal on which the second user ID is used for login is restricted to a predetermined range.

14. The first terminal according to claim 13, wherein the predetermined range includes a right to remotely operate the specific vehicle.

15. The first terminal according to claim 9, wherein the management server device serves to grant the control right for the specific vehicle to a terminal on which a user ID registered in a predetermined list is used for login, and
wherein the control unit is configured to transmit a registration request signal for requesting registration of the second user ID in the predetermined list as the request to the management server device.

16. The first terminal according to claim 9, wherein the predetermined list is a list in which a grant period in which the control right for the specific vehicle is granted to a terminal on which a user ID is used for login in addition to the user ID is registered, and
wherein the control unit is configured to:
allow the first user to additionally input a grant period for the second user ID; and
transmit the registration request signal including the second user ID and the grant period to the management server device.

17. A non-transitory storage medium storing an information processing program for controlling a second terminal which is used by a second user who does not have an administrator right for a specific vehicle, the information processing program causing the second terminal to perform:
a third step of acquiring a first user ID which is a user ID of a first user who has an administrator right for the specific vehicle from a first terminal which is used by the first user; and
a fourth step of transmitting a request for granting a control right for the specific vehicle correlated with the first user ID to the second terminal on which the second user ID is used for login to a management server device that manages the control right for the specific vehicle.

18. The storage medium according to claim 17, wherein the third step includes a step of reading the first user ID which is displayed on a screen of the first terminal using a camera of the second terminal.

19. The storage medium according to claim 18, wherein the first user ID displayed on the screen of the first terminal is displayed as a two-dimensional code.

20. The storage medium according to claim 19, wherein the two-dimensional code is obtained by converting the first user ID to a QR code (registered trademark).
